(19) United States
(12) Patent Application Publication
(10) Pub. No.: US 2017/0318037 A1
(43) Pub. Date: Nov. 2, 2017

(54) DISTRIBUTED ANOMALY MANAGEMENT

(71) Applicant: Hewlett Packard Enterprise Development LP, Houston, TX (US)

(72) Inventors: Jerome Rolia, Kanata (CA); Martin Arlitt, Calgary (CA); Alberto Cueto, Tlaquepaque (MX); Rodrigo Novelo, Tlaquepaque (MX); Wei-Nchih Lee, Palo Alto, CA (US); Gowtham Bellala, Palo Alto, CA (US)

(21) Appl. No.: 15/142,687

(22) Filed: Apr. 29, 2016

(51) Int. Cl. H04L 29/06

(52) U.S. Cl. CPC H04L 63/1416; H04L 63/1425

(57) ABSTRACT

Examples relate to distributed anomaly management. In one example, a computing device may: receive real-time anomaly data for a first set of client devices, wherein the received anomaly data includes: anomalous network behavior data received from a network intrusion detection system (NICKS) monitoring network traffic behavior, anomalous host event data received from a host intrusion detection system (HIDS) monitoring host events originating from client devices in the first set, and anomalous process activity data received from a trace intrusion detection system (TIDS) monitoring process activity performed by client devices in the first set; for each client device in the first set of client devices for which anomaly data is received, associate the received anomaly data with the client device; and determine, for a particular client device, a measure of risk, wherein the measure of risk is dynamically adjusted based on the received real-time anomaly data.

### BACKGROUND

Managing information technology (IT) is an important part of a properly performing network of computing devices. Network monitoring devices and/or system administrators are often used to identify and respond to various events to protect a computing device or network from an attack or mitigate damage from a problem or failure. Traditional anti-virus approaches are also used to protect network devices, but these approaches do not identify new threats or problems, which may leave computing devices exposed for an extended period of time.

### BRIEF DESCRIPTION OF THE DRAWINGS

The following detailed description references the drawings, wherein:

FIG. 1 is a block diagram of an example computing device for distributed anomaly management.

FIG. 2 is a data flow depicting distributed anomaly management.

FIG. 3 is a data flow depicting an anomaly management system sharing data.

FIG. 4 is a flowchart of an example method for performing distributed anomaly management.

FIG. 5 is a flowchart of an example method for managing anomalies in a distributed manner.

### DETAILED DESCRIPTION

IT forensic devices may be used to identify real and/or potential threats or other problems by analyzing certain types of computing device data. For example, a network intrusion detection system (NIRS) is an example system that monitors network traffic for client devices operating on a network, a host intrusion detection system (HIDS) is an example system that monitors host events originating from client devices, and a trace intrusion detection system (TIDS) is an example system that monitors process activity performed by client devices. Each forensic device may independently detect anomalies in the data they analyze and provide their respectively detected anomaly data to an anomaly management system (AMS) that aggregates and correlates the anomaly data for a particular domain, e.g., network of computing devices.

The AMS may take advantage of a distributed architecture design by sending and receiving certain anomaly-related information with AMSs associated with other security domains, or networks. Sharing information between AMSs may facilitate both identification and remediation of potential threats. Each AMS can operate on its own, and does not need to rely on a centralized event management controller for obtaining updated information about risks associated with specific anomalies or combinations of anomalies. Communicating directly with AMS devices responsible for managing anomalies of separate networks may facilitate accurate and more rapid classification of anomalies, e.g., as malicious, benign, critical, trivial, or some other classification, as compared to a centralized anomaly management scheme, which may not be permitted to aggregate such information due to business, regulatory, or other requirements.

By way of example, an AMS may be deployed for a particular network of computing devices. A NIDS, HIDS, and TIDS may also be deployed to monitor activities of the various devices included in the network. Each device, e.g., the NIDS, HIDS, and TIDS, may identify anomalies for the computing devices on the network, and anomaly data may be forwarded to the AMS. The AMS may associate each computing device with the corresponding anomalies provided by the NILS, HIDS, and TIDS and, in some implementations, determine measures of risk for each of the computing devices based on the anomalies. The measures of risk may be determined based on combinations of anomalies, additional information provided by the NIDS, HIDS, and TIDS, and/or information provided by other AMS devices. For example, a particular computing device that experienced an anomalous host event in combination with anomalous network activity might be rated by the AMS as moderately risky.

In some implementations, The AMS may query other AMS devices for information related to the same or a similar combination of anomalies in their respective network devices. Data relevant to the combination of anomalies may be provided to the AMS by the other AMSs, and may be used to adjust the measure of risk for the particular computing device. E.g., in situations where other AMSs commonly encounter the combination of anomalies in a non-malicious context, the measure of risk for the particular computing device may decrease; while in situations where other AMS rarely encounter the combination of anomalies or only encounter the combination of anomalies in a malicious context, the measure of risk for the particular computing device may increase. Measures of risk may be dynamically updated, e.g., based on new anomaly data received by the NIDS, HIDS, or TIDS and/or based on shared data provided by other AMSs.

While example systems described herein for managing anomalies are depicted and described as including a NIDS, HIDS, and TIDS, other systems may be used to monitor devices and activity on devices to provide anomaly data to the AMS. Different systems may be deployed for different types of anomaly management, e.g., a NIDS, HIDS, and/or TIDS may be used in a security context, while a TIDS, hardware performance monitoring system, and/or software performance analytics system may be used in a performance monitoring context, e.g., for load balancing devices. Other systems may consider functional correctness. Further details regarding the distributed management of anomalies by an AMS are provided in the paragraphs that follow.

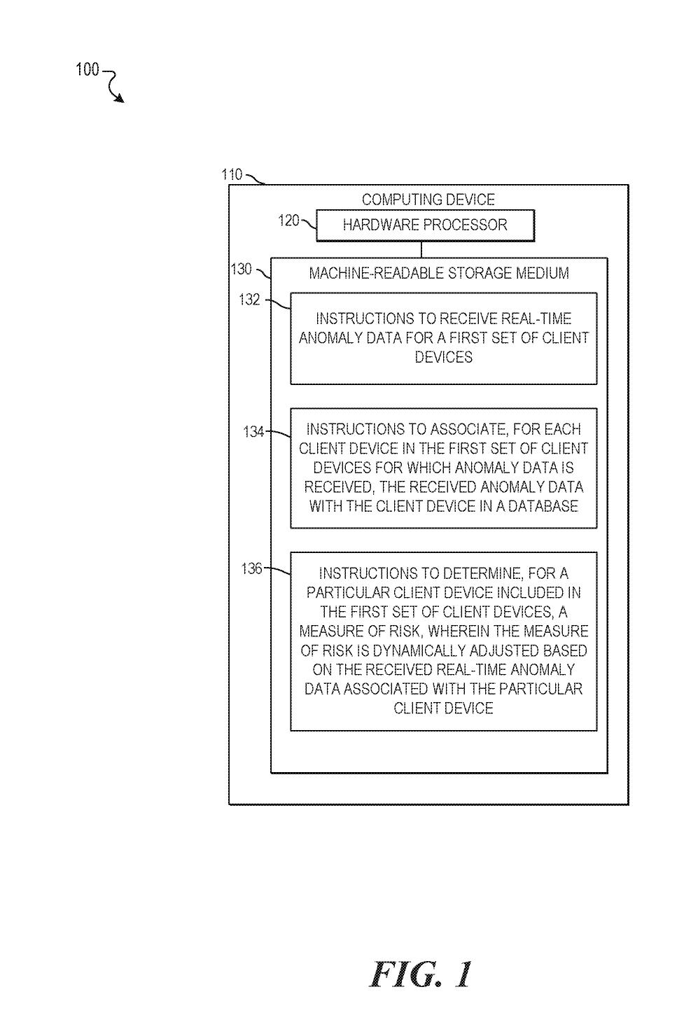

Referring now to the drawings, FIG. 1 is a block diagram 100 of an example computing device 110 for distributed anomaly management. Computing device 110 may be, for example, a personal computer, a server computer, network router, network switch, or any other similar electronic device capable of processing anomaly data. In the example implementation of FIG. 1, the computing device 110 includes a hardware processor, 120, and machine-readable storage medium, 130.

Hardware processor 120 may be one or more central processing units (CPUs), semiconductor-based microprocessors, and/or other hardware devices suitable for retrieval and execution of instructions stored in machine-readable storage medium, 130. Hardware processor 120 may fetch, decode, and execute instructions, such as 132-136, to control processes for distributed anomaly management. As an alternative or in addition to retrieving and executing instructions, hardware processor 120 may include one or more electronic circuits that include electronic components for performing the functionality of one or more instructions, e.g., a Field Programmable Gate Array (FPGA) or Application Specific Integrated Circuit (ASIC).

A machine-readable storage medium, such as 130, may be any electronic, magnetic, optical, or other physical storage device that contains or stores executable instructions. Thus, machine-readable storage medium 130 may be, for example, Random Access Memory (RAM), non-volatile RAM (NVRAM), an Electrically Erasable Programmable Read-Only Memory (EEPROM), a storage device, an optical disc, and the like. In some implementations, storage medium 130 may be a non-transitory storage medium, where the term “non-transitory” does not encompass transitory propagating signals. As described in detail below, machine-readable storage medium 130 may be encoded with executable instructions: 132-136, for distributed anomaly management.

As shown in FIG. 1, the hardware processor 120 executes instructions 132 to receive real-time anomaly data for a first set of client devices. The anomaly data includes: anomalous network behavior data received from a network intrusion detection system (KIDS) monitoring network traffic behavior for client devices in the first set, anomalous host event data received from a host intrusion detection system (HIDS) monitoring host events originating from client devices in the first set, and anomalous process activity data received from a trace intrusion detection system (TIDS) monitoring process activity performed by client devices in the first set.

By way of example, a first set of client devices may be a network of multiple server devices that each perform one or more functions. A NIDS may analyze network traffic transferred by each of the server devices in the first set. Anomalies are detected in a variety of ways, e.g., by comparing data included in network packets to expected data, known errors, or known malicious data or patterns of data. When the NIDS identifies an anomaly, e.g., an unusually large number of DNS queries sent by a particular server, the NIDS may send—to the AMS—anomaly data identifying the server and the particular anomaly. A HIDS may analyze actions taken by a given host device, e.g., one of the servers, to identify anomalous events. For example, a HIDS agent operating on each server included in the first set may analyze events that take place on the server devices to identify certain events that are known to be malicious, potentially malicious, or indicative or a failure in hardware and/or software. As with the NIDS, when the HIDS identifies an anomaly, e.g., an incorrect password attempt or application error, the HIDS may send—to the AMS—anomaly data identifying the particular server and the particular anomaly.

A TIDS may analyze process activity of each of the servers in the first set. The activities monitored may vary, and may include information recorded by the NIDS or HIDS. For example, the TIDS may monitor sequences of system calls, function calls, commands, scripting steps, user activities, communication patterns, etc. During operation, the example servers may often perform the same or similar series of actions. In an Internet of Things (IoT) context, for example, many client devices may be substantially similar and expected to perform in a manner similar to other substantially similar devices. Process activity may be sent to the TIDS by a TIDS agent operating on each server device. In a situation where a certain process or processes perform a new, unusual, unexpected, and/or known malicious sequence of actions, a TIDS may identify the process activity as an anomaly. The anomaly identified by the TIDS may be sent to the AMS along with data identifying the particular server and the anomaly.

As used herein, real-time handling of data occurs as data becomes available, and “real-time” encompasses natural delays occurring in transmission or processing of data. In some examples, data handled in real-time is handled when it is received and/or in intervals, e.g., intervals of 1 second, 10 seconds, 1 minute, 5 minutes, etc. By way of example, the NIDS, HIDS, and TIDS may handle various streams of data from client devices in the first set in real-time, e.g., as the data streams are received by the NIDS, HIDS, and TIDS. Each anomaly identified in the data streams is sent to the computing device 110, e.g., in real-time responsive to identification of the anomaly.

The hardware processor 120 executes instructions 134 to associate, for each client device in the first set of client devices for which anomaly data is received, the received anomaly data with the client device in a database. Associating anomalies with client devices may allow, for example, the computing device 110 to build and maintain a database that identifies different types of anomalies for each client device in the first set. For example, a database may specify, for a particular client device, several different anomalies from the NIDS, HIDS, and TIDS.

In some implementations anomaly data may be associated with one or more characteristics of the client devices. For example, anomaly data may be associated with one or a combination of specific operating systems processes, application processes, clusters of applications, and/or hardware features. Associating anomalies at different levels of abstraction beyond the client device may allow, for example, the computing device 110 to build and maintain a database that identifies different types of anomalies applicable to the various characteristics of client devices. For example, a database may specify, for a particular application process, several different anomalies from the NIDS, HIDS, and TIDS. In some implementations, characteristics may be non-identifying in that the characteristics and associations do not specify which source client device was the source of the anomaly or anomalies.

In some implementations, the characteristics may be used to determine how anomaly information is shared in a distributed network of AMSs. For example, the characteristics may be used to determine which anomaly information can be shared with which AMSs, what information can be shared, when it should be shared, where the information is permitted to be shared, e.g., geographically due to regulatory or other requirements, and/or why the information is shared—e.g., for collaborative purposes in terms of achieving an objective for the characteristics. For example, a particular business entity's AMS may be permitted to share a portion of a particular anomaly for a particular characteristic with an AMS of a competing business entity, whereas the sharing may not be permitted for some other characteristics and/or anomalies.

The hardware processor 120 executes instructions 136 to determine, for a particular client device included in the first set of client devices, a measure of risk, wherein the measure of risk is dynamically adjusted based on the received real-time anomaly data associated with the particular client device. Risk may generally refer to a measure of likelihood and/or confidence that a service, application, device, or other monitored entity is not operating as intended, failing, and/or being maliciously interfered with. Risk may be determined for a particular client device in a variety of ways. In some implementations, each anomaly associated with the particular client device may have a risk value associated with it. The risk value may be provided by the corresponding NIDS, HISS, or TICS that provided the anomaly and/or generated by the computing device 110. Risk values for various anomalies experienced by the particular client device may be used to dynamically adjust a measure of risk for the client device over time. Individual risk values for separate anomalies may be aggregated, multiplied, applied to a function, or otherwise used to determine a measure of risk for the client device experiencing the anomalies.

In some implementations, combinations of anomalies may be associated with certain risk values. The combinations may be for anomalies from the same NIDS, HIDS, or TIDS, or from a combination of anomalies across two or more of the intrusion systems. By way of example, a particular server computer being monitored by the computing device 110 may experience several anomalies reported by each of the NIDS, HIDS, and TIDS. Each anomaly may be associated with a risk value. In one example, the computing device 110 may aggregate the risk values to determine a measure of risk for the particular server computer. In situations where certain combinations of anomalies are known to be risky, an additional risk value may be used to multiply or add to the measure of risk for the particular server computer. For example, a port scan anomaly detected by the NIDS may be associated with a moderate, but not alarming, measure of risk for the server computer. Later, a password attack on the server computer may be detected by the HIDS and may also be associated with a moderate measure of risk. However, the co-occurrence of these particular anomalies may, in some situations, be associated with a known type of attack and, accordingly, may cause a significant increase in the measure of risk associated with the particular server computer. As noted above, the measure of risk may be dynamically updated over time, e.g., based on new anomalies associated with the server computer and/or new information, acquired by the computing device 110, which is relevant to the anomalies experienced by the server computer.

In some implementations, the computing device 110 maintains a dictionary for the first set of client devices. A dictionary may be used, for example, to store expected client device behavior and/or expected anomalies. In this situation, the computing device 110 may determine to attribute a relatively small amount of risk, or no risk, to particular anomalies that are expected behavior for particular client devices, processes, and/or applications. A dictionary may also be used to identify unexpected anomalies, e.g., anomalies that do not often occur for particular client devices, processes, and/or applications in the first set. Unexpected anomalies may, in some situations, be attributed a higher level of risk based on the rarity, even in situations where the source NIDS, HIDS, or TIDS does not label these anomalies as particularly risky. In some implementations, the dictionary may be dynamically updated over time, e.g., based on client device behavior and anomalies and/or data shared with the computing device 110 by other devices.

In some implementations, the computing device 110 may send a follow-up request to the NIDS, HIDS, and/or TIDS based on the received anomaly data associated with the particular client device. The follow-up request causes the NIDS, HIDS, and/or TIDS to perform addition analysis for the particular client device. For example, a particular anomaly may cause the computing device 110 to initiate additional monitoring for specific types of data and/or anomalies. The additional analysis may be chosen by the computing device 110 in a variety of ways, e.g., based on behavioral analysis and/or a library of related anomalies that are indicative of malicious behavior. For example, after receiving a port scan anomaly for a particular server computer from the NIDS, the computing device 110 may instruct the HIDS to monitor the particular computing device for administrator login events.

As noted above, the computing device 110 may logically reside at the edge of a network that includes the first set of client devices. Other similar computing devices may manage anomalies for other sets of client devices, e.g., in separate networks or security domains. In some implementations, information may be shared among the computing device 110 and other similar computing devices, e.g., in a manner designed to facilitate identifying risks in monitored devices. The manner in which information is shared between computing devices, and the actual data shared, may vary.

In some implementations, the computing device 110 generates redacted anomaly data that includes a subset of the information included in the anomalies received from the HIDS, NIDS, and TIDS. For example, in generating the redacted anomaly data, the computing device 110 may remove data that identifies the particular client device that was the source of the anomaly. Other redacted information may include data that identifies an entity that owns, operates, or makes use of the first set of client devices, e.g., in a manner designed to preserve anonymity for users of the first set of client devices. The redacted anomaly data may be provided to one or more separate computing devices that each manage anomalies for their respective sets of client devices. Data that remains included in the redacted anomaly data may be of use to other computing devices that manage anomalies; the redacted anomaly data may specify expected behavior or anomalies for a client device, operating system process, virtual machine, or application, for example. By sharing expected behavior and expected anomalies with a peer computing device, the peer device may use the redacted anomaly data to reduce false positives. In situations where the shared data includes information identified as risky for a particular type of computing device, operating system process, virtual machine, or application, the redacted anomaly may be used to positively identify potentially risky behavior occurring in the peer computing device's network.

In some implementations, the computing device 110 may receive, from another computing device that manages anomalies for another set of client devices, shared data that is relevant to the received anomaly data. For example, the computing device 110 may request, from one or more peer devices, data related to a particular anomaly, combination of anomalies, and/or client device characteristic(s). In situations where a peer computing device has relevant information, e.g., expected anomalies for a particular application, anomalies known to be malicious for a particular operating system process, and/or risk values for specific anomalies, the peer device may provide that relevant information to the computing device 110. The computing device 110 may then use the shared data, e.g., by using the shared data to update or determine the measure of risk for the particular client device.

The computing device 110 may work with any number of other similar computing devices to share relevant data in a peer to peer fashion. In addition to using the shared data to update or determine measures of risk for client devices, processes, applications, etc., the shared data may also be used for other purposes, such as updating a dictionary of expected anomalies. Shared data may be redacted in a number of ways in a manner designed to protect sensitive information on client devices that are managed by the peer anomaly management computing devices. In some implementations, data sharing may also take place between the NIDS, HIDS, and TIDS, in a similar peer to peer fashion. This may allow, for example, the TIDS to receive—from another TIDS monitoring a different set of client devices—redacted information that may enable the TIDS to identify a new threat in a series of actions taken by a particular host application.

The measures of risk produced by the computing device 110 may be used in a variety of ways. Client devices, operating system processes, applications, and other entities having an associated measure of risk may be ranked according based on their risk. Administrators may be notified in response to certain events, e.g., threshold measures of risk being met. In some implementations, remedial measures may be taken in response to particular risks, e.g., particular combinations of anomalies may have known remedial measures which the computing device 110 can initiate. In some implementations, one measure of risk for a particular client device may affect other client devices in the first set. For example, in response to determining a high measure of risk for a particular client device, the computing device 110 may initiate additional monitoring or assign increased risk values to other similar client devices in the first set.

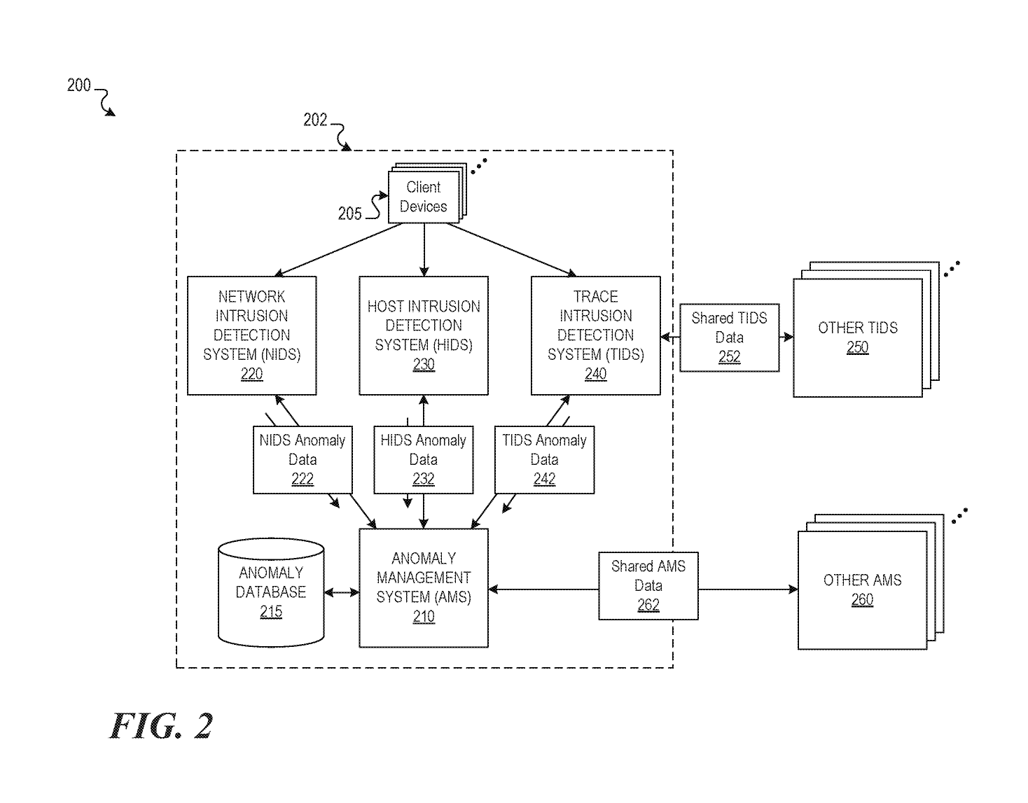

In some implementations, data sharing among peer computing devices may be triggered by a threshold measure of risk being determined. For example, in response to the measure of risk for a particular client device meeting a risk threshold, the computing device 110 may request shared data relevant to the particular client device from other peer computing devices. Threshold measures of risk, as used herein, are not limited to absolute values, e.g., rankings may be used as a threshold such that the top N client device risk measures may meet a threshold for triggering a particular action, where N is a positive integer. Further examples and details regarding distributed anomaly management are described with respect to FIGS. 2-5 below.

FIG. 2 is a data flow 200 depicting distributed anomaly management using an anomaly management system (AMS) 210. The AMS 210 may be the same as or similar to the computing device 110 of FIG. 1. The AMS 210 works with a NIDS 220, HIDS 230, and TIDS 240 to manage anomalies of client devices 205 within a particular network 202, e.g., a security domain. The data flow 200 also depicts an anomaly database 215 in communication with the AMS 210. The anomaly database 215 may be a storage medium, such as the computer readable storage medium 130 of FIG. 1, for storing anomaly associations, risk measurements, and other related information. The other TIDS 250 and other AMS 260 depicted in the example data flow 200 are exemplary of separate systems that manage anomalies for networks separate from the network 202.

During operation, each of the NIDS, HIDS, and TIDS monitors certain information obtained from the client devices 205 to identify anomalies in real-time. The NIDS, HIDS, and TIDS may store various pieces of data obtained from the client devices 205, including anomaly data, e.g., in their own respective data storage devices. The NIDS 220 sends at least some of the NIDS anomaly data 222 to the AMS 210, the HIDS 230 sends at least some of the HIDS anomaly data 232 to the AMS 210, and the TIDS 240 sends at least some of the TIDS anomaly data 242 to the AMS 210. At the AMS 210, the received anomaly data is associated with the corresponding client device 205 that was the source of the anomaly. In some implementations, the AMS 210 stores associations of the anomalies with one or more characteristics of the client devices 205. For example, the AMS 210 may associate an anomaly with the application, virtual machine, or operating system process that corresponds to the anomaly.

By way of example, the client devices 205 may be a set of web servers, each of which is being monitored by the NIDS, HIDS, and TIDS devices. Network traffic to and from the web servers is monitored by the NIDS 220, which may store a variety of information related to the network traffic and identify anomalies in the network traffic. In response to identifying a network traffic anomaly, the NIDS 220 may store information about the anomaly and send NIDS anomaly data 222 to the AMS 210. The NIDS 220 may store more information regarding the anomaly than is included in the NIDS anomaly data 222. For example, the NIDS 220 may store copies of network packets that triggered the anomaly and information regarding network traffic that preceded and followed the anomaly, while the NIDS anomaly data 222 provided to the AMS 210 may include less information, e.g., an identification of the type of anomaly and associated server, process, etc.

Using the web server example, the HIDS 230 may have a corresponding HIDS agent running on each of the web servers. In this situation, the HIDS agent is responsible for monitoring certain host actions taken on the web servers and reporting information about some or all of the actions to the HIDS 230. As with the NIDS 220, the HIDS 230 may store a variety of information related to a host anomaly, including more than what is sent to the AMS 210 in the HIDS anomaly data 232.

The TIDS 240 may also have a corresponding agent on each of the web servers, which may be the same agent that reports to the HIDS 230 or a separate agent. The TIDS 240 receives activity information from the web servers' agents and analyzes the processes to determine if particular sequences of actions, e.g., system calls, function calls, commands, scripting steps, user activities, communication patterns, etc., is anomalous. As with the NIDS 220 and HIDS 230, the TIDS 240 may store a variety of information related to anomalous sequences of actions taken on a web server, including more than what is sent to the AMS 210 in the TIDS anomaly data 242. As shown in the example data flow 200, the TIDS may share TIDS data 252, redacted or otherwise, with other TIDS 250 operating in different networks. The sharing of TIDS data 252 allows every TIDS to update itself on process activity that may be potentially harmful or benign in a peer to peer fashion.

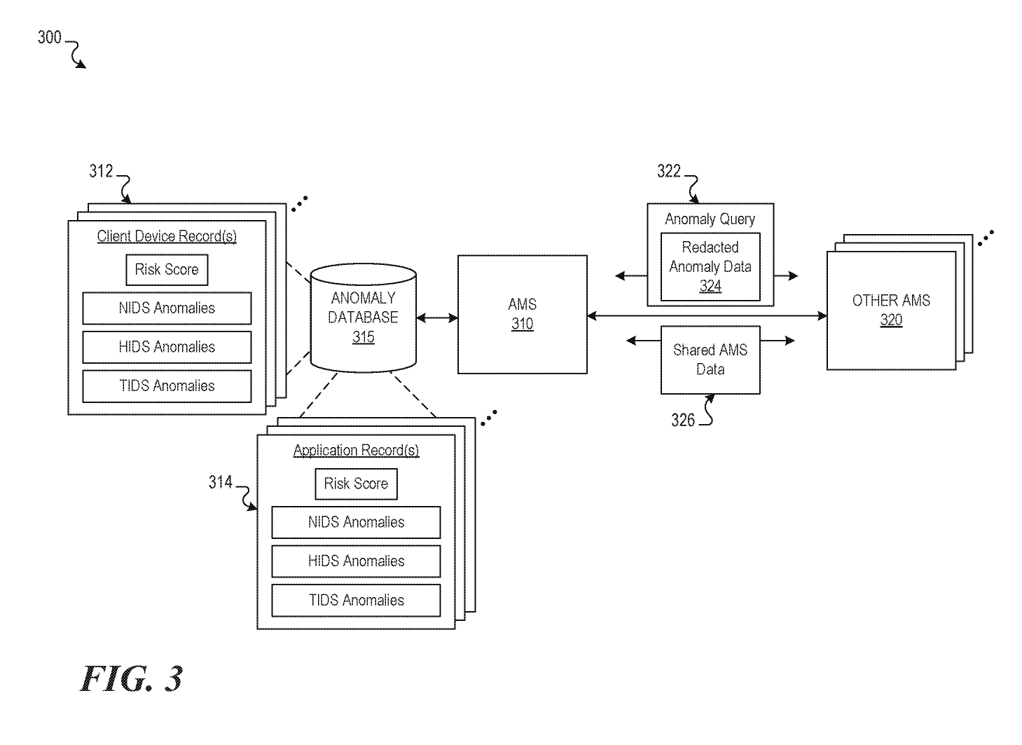

The AMS 210 may use the received anomaly data and received shared AMS data 262 in a variety of ways. The AMS 210 may determine measures of risk for the client devices 205, determine remedial measures to be taken to correct potential problems with the client devices 205, instruct the NIDS 220, HIDS 230, and/or TIDS 240 to gather and/or provide additional information for particular client devices 205. The NIDS 220, HIDS 230, and TIDS 240 may, in response to a request for additional information from the AMS 210, initiate additional monitoring and/or provide the AMS 210 with previously collected data relevant to particular client devices or anomalies. The determination of risk and sharing of AMS data is described in further detail with respect to the example depicted in FIG. 3.

FIG. 3 is a data flow 300 depicting an anomaly management system (AMS 310) sharing data. The data is shared with other AMS 320 and, in the example data flow 300, may be used for calculating measures of risk, or risk scores, for client devices and applications monitored by the AMS 310. The anomaly database 315 may be the same as or similar to the anomaly database 215 of FIG. 2, and generally is used to store information related to anomalies.

The example anomaly database 315 includes example client device records 312 and example application records 314. Each of the client device records 312 specifies anomalies that are associated with a particular client device. For example, each anomaly received by the AMS 310 is associated with the client device that was the source of the anomaly in a client device record. Each client device record also includes a risk score, which is a measure of risk designed to provide an indication of the risk of potentially malicious or otherwise faulty activity occurring on the corresponding client device. As noted above, the measures of risk, or risk scores, may be determined in a variety of ways. For example, each anomaly may for some characteristic be associated with an individual risk score, and the AMS 310 may calculate a client device risk score based on the individual risk scores of the anomalies experienced by the client device. In some implementations, the anomaly database may include anomaly combinations that were previously assigned a risk value, e.g., indicating that certain anomaly combinations are more or less risky than the anomalies would be alone. The AMS 310 may generate the information used to determine risk scores on its own, e.g., using machine learning and learning expected anomalies for the devices, applications, etc. that it monitors. The AMS 310 may also receive information from a separate entity that it may use, alone or in combination with its own determinations, to assign risk values to anomalies or combinations of anomalies.

The example data flow 300 also depicts application records 314. As with client device records 312, the application records include, for each application, anomalies and risk score. The anomalies and risk score may each be associated with a particular application that operates on client devices monitored by the AMS 310. For example, multiple web servers monitored by the AMS 310 may run the same web application. The AMS 310 may create, update, and use one record for the web application, using anomalies that correspond to the web application and which may have been provided by any of the web servers. In some implementations, other records for other client device characteristics may also be managed by the AMS 310, In some implementations, the device characteristic records, such as the application records 314, are redacted so the particular client device that was the source of each anomaly is not included in the application records 314. Risk scores for applications may be determined using the same or similar methods as those used to determine risk scores for client devices described above. The application risk scores may also be used in the same or similar ways, e.g., to identify and/or remediate potentially erroneous, malicious, or otherwise harmful activity associated with a particular application that may be running on multiple client devices within the security domain monitored by the AMS 310.

The example data flow 300 also depicts the sharing of data between the AMS 310 and other AMS 320. In this example, the AMS 310 sends an anomaly query 322 to at least one of the other AMS 320, The anomaly query 322 includes redacted anomaly data 324. For example, the AMS 310 may request additional information regarding a variety of things, such as a particular anomaly or combination of anomalies, and/or anomalies related to a particular application, operating system process, etc. The query 322 may be issued, in general, to obtain more information that the AMS 310 may use to determine whether an anomaly or anomalies are likely to be benign or if they may be indicative of malicious or otherwise problematic activity. The redacted anomaly data 324 may be redacted to prevent sharing any information that might identify particular client devices, software versions, etc. The other AMS 320 provides shared AMS data 326 in response to the query 322, The shared AMS data 326 may be redacted by the other AMS prior to sending, and it may include information relevant to the anomaly or anomalies associated with the query 322. For example, in a situation where the AMS 310 requests additional information regarding a particular anomaly, one or more other AMS 320 may provide some redacted information regarding that particular anomaly. The shared AMS data 326 may then be recorded by the AMS 310 in the anomaly database and, in some implementations, used to determine and/or update risk scores.

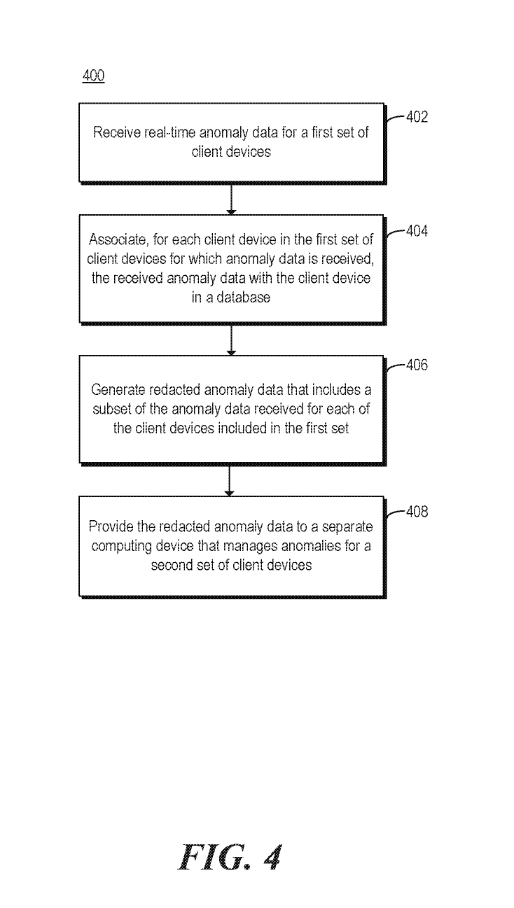

FIG. 4 is a flowchart of an example method 400 for performing distributed anomaly management. The method 400 may be performed by a computing device, such as a computing device described in FIG. 1. Other computing devices may also be used to execute method 400. Method 400 may be implemented in the form of executable instructions stored on a machine-readable storage medium, such as the storage medium 130, and/or in the form of electronic circuitry.

Real-time anomaly data for a first set of client devices is received (402). The anomaly data includes at least one of i) anomalous network behavior data received from a NIDS monitoring network traffic for client devices in the first set, ii) anomalous host event data received from a HIDS monitoring host events originating from client devices in the first set, or iii) anomalous process activity data received from a TIDS monitoring process activity performed by client devices in the first set. In some implementations, the anomaly data is redacted, e.g., information may be removed from the raw data collected by the corresponding NIDS, HIDS, or TIDS before the anomaly data is received.

For each client device in the first set of client devices for which anomaly data is received, associate the received anomaly data with the client device in a database (404). The database is designed to allow every anomaly associated with a client device to be tracked. In some implementations, anomalies may be periodically discarded and/or disassociated with client devices, e.g., after determining that they are no longer relevant, risky, or after a predetermined period of time.

In some implementations, shared data that is relevant to received anomaly data associated with a particular computing device is received from a separate computing device. For example, one AMS may receive shared data from another AMS that manages anomalies for a separate set of client devices. In this situation, a measure of risk may be determined for the particular client device based on i) the received anomaly data and ii) the shared data. In some implementations, the shared data includes a risk indicator, and the measure of risk may be determined based on the risk indicator. For example, a risk score may be provided for a particular anomaly by a peer AMS, and the risk score may be used to determine or update a measure of risk for the particular client device associated with the anomaly.

In some implementations, a follow-up request may be sent to at least one of the NIDS, HIDS, or TIDS based on the received anomaly data. As discussed above, in this situation the follow-up request causes the NIDS, HIDS, or TIDS to collect additional data and/or perform additional analysis for the particular client device associated with the anomaly data. This may allow identification of additional anomalies that may not otherwise be captured without the additional analysis.

Redacted anomaly data is generated that includes a subset of the anomaly data received for each of the client devices included in the first set (406). Redaction is performed in a manner designed to remove certain identifying details from anomaly data and associations. For example, a particular server computer may be associated with a particular anomaly that came from one of the NIDS, HIDS, or TIDS. The anomaly data may include the identity of the particular server computer, e.g., using IP and/or MAC address, and details regarding the actual anomaly, e.g., the anomalous event that triggered the anomaly data being generated and the system that recognized the event. In some implementations, other information may be included in anomaly data, e.g., hardware and/or software details regarding the particular server computer. When redacting the anomaly data, identifying characteristics, such as an IP or MAC address, are some examples of data that may be redacted.

The redacted anomaly data is provided to a separate computing device that manages anomalies for a second set of client devices (408). The second set of client devices is different from the first set of client devices. Sharing redacted anomaly data enables separate computing devices, e.g., separate AMSs, to independently manage anomalies for separate sets of client devices in a distributed manner while updating each other in a peer-to-peer fashion.

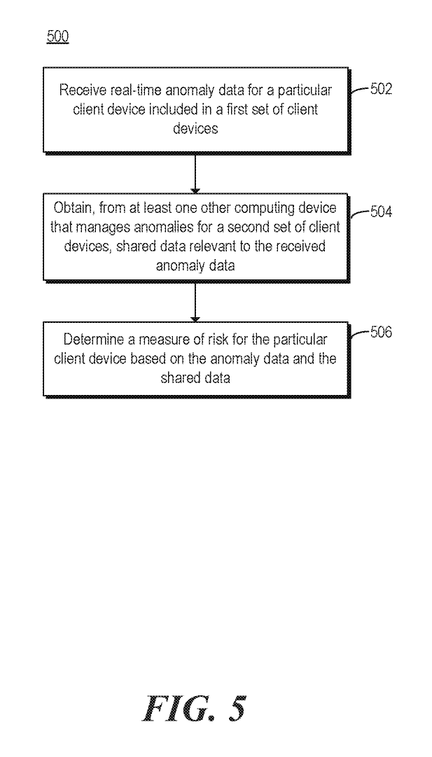

FIG. 5 is a flowchart of an example method 500 for managing anomalies in a distributed manner. The method 500 may be performed by a computing device, such as a computing device described in FIG. 1. Other computing devices may also be used to execute method 500. Method 500 may be implemented in the form of executable instructions stored on a machine-readable storage medium, such as the storage medium 130, and/or in the form of electronic circuitry.

Real-time anomaly data for a particular client device included in a first set of client devices is received (502). The anomaly data includes at least one of i) anomalous network behavior data received from a network device monitoring network traffic for the particular client device, ii) an anomalous host event data received from a host event device monitoring host events originating from the particular client device, or iii) anomalous process activity data received from a trace device monitoring process activity performed by the particular client device.

Shared data that is relevant to the received anomaly data is obtained from at least one other computing device that manages anomalies for a second set of client devices (504). For example, one AMS may receive shared data from another AMS that manages anomalies for a separate set of client devices. The shared data may include information that may be used to determine whether an anomaly is potentially problematic or benign. For example, shared data provided to an AMS may include records of the anomaly that occurred in a set of devices managed by a peer AMS and that were determined to be benign or normal. In this situation, the AMS may use the shared data to determine that the same or a similar anomaly, e.g., occurring on similar client devices or software, is likely to be benign.

A measure of risk is determined for the particular client device based on the anomaly data and the shared data (506). The measure of risk provides an indication of whether the anomaly data indicates malicious or otherwise harmful behavior. In some implementations, the shared data includes a risk indicator that corresponds to the anomalous network behavior data, anomalous host event data, or the anomalous process activity data. In this situation, the measure of risk may be based on the risk indicator, which may be, for example, a numerical value or categorical label. The measure of risk may be for some characteristic or composition of characteristics that span one or more client devices.

In some implementations, the anomaly data is associated with a non-identifying characteristic of a particular client device. Characteristics may be non-identifying in that the characteristics and associations do not specify which source client device was the source of the anomaly or anomalies, Examples characteristics may include one or a combination of specific operating systems processes, application processes, clusters of applications, and/or hardware features. In this situation, a measure of risk may be based on other anomaly data associated with the non-identifying characteristic. For example, several web servers may be the source of several separate anomalies that are associated with a particular operating system software that is running on all of the web servers. A measure of risk may be determined for the particular operating system software, and the measure of risk may be used to evaluate the risk for a different web server that also runs the same operating system software—one managed by the same AMS or by another AMS, e.g., using shared operating system software anomaly data.

In some implementations, using a non-identifying characteristic, redacted anomaly data may be generated that includes a subset of the anomaly data received for a particular client device, and that redacted anomaly data may be provided to one of the separate computing devices that manages anomalies for a separate set of client devices. By way of example, an AMS may be monitoring a set of server devices that run a particular virtual machine software. Anomalies that come from servers that run that particular virtual machine software may be associated with that particular software in the anomaly database in a non-identifying manner. This information may be redacted and provided to a peer AMS, e.g., so that the peer AMS may use anomaly information relevant to the particular virtual machine software to evaluate anomalies in its own domain.

In some implementations where the AMS shares data, the AMS may determine, based on the non-identifying characteristic or the anomaly data, that a subset of other AMSs is permitted, or not permitted, to receive the redacted anomaly data. Based on the determination, the AMS may decide which AMS devices are permitted to share certain anomaly data. For example, where a first subset of peer AMSs is permitted to receive anomaly data related to a particular characteristic and a second subset of peer AMSs is not permitted to receive the same anomaly data, the AMS device may only share the anomaly data with the permitted AMSs.

While the methods 400 and 500 are described with respect to a single computing device, various portions of the methods may be performed by other computing devices. For example, one computing device may be responsible for collecting and associating anomaly data in a databased while another computing device is responsible for sharing data with other peer computing devices.

The foregoing disclosure describes a number of example implementations for distributed anomaly management. As detailed above, examples provide a mechanism for using distributed AMSs to manage anomalies for separate networks.

We claim:

1. A computing device for distributed anomaly management, the computing device comprising:
a hardware processor; and
a data storage device storing instructions that, when executed by the hardware processor, cause the hardware processor to:
receive real-time anomaly data for a first set of client devices, wherein the received anomaly data includes:
anomalous network behavior data received from a network intrusion detection system (NIRS) monitoring network traffic behavior for client devices in the first set,
anomalous host event data received from a host intrusion detection system (HIDS) monitoring host events originating from client devices in the first set, and
anomalous process activity data received from a trace intrusion detection system (TIDS) monitoring process activity performed by client devices in the first set;
for each client device in the first set of client devices for which anomaly data is received, associate the received anomaly data with the client device in a database; and
determine, for a particular client device included in the first set of client devices, a measure of risk, wherein the measure of risk is dynamically adjusted based on the received real-time anomaly data associated with the particular client device.

2. The computing device of claim 1, wherein the instructions further cause the hardware processor to:
receive, from at least one other computing device that manages anomalies for a second set of client devices, shared data relevant to the received anomaly data associated with the particular client device, and
wherein the measure of risk is determined based on the shared data.

3. The computing device of claim 1, wherein the instructions further cause the hardware processor to:
send, to at least one of the NIDS, HIDS, or TIDS, a follow-up request based on the received anomaly data associated with the particular client device, the follow-up request causing the at least one NIDS, HIDS, or TIDS to perform additional analysis for the particular client device.

4. The computing device of claim 1, wherein the instructions further cause the hardware processor to:
determine that the measure of risk for the particular client device meets a threshold measure of risk, and in response:
determine, for each other client device included in the first set, a second measure of risk based on i) the received anomaly data associated with the particular client device, and ii) the received anomaly data associated with the other client device.

5. The computing device of claim 1, wherein the instructions further cause the hardware processor to:
generate redacted anomaly data that includes a subset of the anomaly data received for each of the client devices included in the first set; and
provide the redacted anomaly data to a separate computing device that manages anomalies for a second set of client devices.

6. A method for distributed anomaly management, implemented by a hardware processor, the method comprising:
receiving real-time anomaly data for a first set of client devices, wherein the received anomaly data includes at least one of:
anomalous network behavior data received from a network intrusion detection system (NIDS) monitoring network traffic for client devices in the first set,
anomalous host event data received from a host intrusion detection system (HIDS) monitoring host events originating from client devices in the first set, or
anomalous process activity data received from a trace intrusion detection system (TIDS) monitoring process activity performed by client devices in the first set;
for each client device in the first set of client devices for which anomaly data is received, associating the received anomaly data with the client device in a database;
generating redacted anomaly data that includes a subset of the anomaly data received for each of the client devices included in the first set; and
providing the redacted anomaly data to a separate computing device that manages anomalies for a second set of client devices.

7. The method of claim 6, further comprising:
receiving, from the separate computing device, shared data relevant to received anomaly data associated with a particular client device included in the first set of client devices; and
determining, for the particular client device, a measure of risk based on i) the received anomaly data associated with the particular client device; and ii) the shared data.

8. The method of claim 7, further comprising:
sending, to at least one of the NIDS, HIDS, or TIDS, a follow-up request based on the received anomaly data associated with the particular client device, the follow-up request causing the at least one NIDS, HIDS, or TIDS to perform additional analysis for the particular client device.

9. The method of claim 7, further comprising:
determining that the measure of risk for the particular client device meets a threshold measure of risk, and in response:
determining, for each other client device included in the first set, a second measure of risk based on i) the received anomaly data associated with the particular client device, and ii) the received anomaly data associated with the other client device.

10. The method of claim 7, wherein:
the shared data includes a risk indicator, and
the measure of risk is determined for the particular client device based on the risk indicator.

11. A non-transitory machine-readable storage medium encoded with instructions executable by a hardware processor of a computing device for distributed anomaly management, the machine-readable storage medium comprising instructions to cause the hardware processor to:
receive real-time anomaly data for a particular client device included in a first set of client devices, wherein the received anomaly data includes at least two of:
anomalous network behavior data received from a network device monitoring network traffic for the particular client device,
anomalous host event data received from a host event device monitoring host events originating from the particular client device, or
anomalous process activity data received from a trace device monitoring process activity performed by the particular client device;
obtain, from at least one other computing device that manages anomalies for a second set of client devices, shared data relevant to the received anomaly data; and
determine a measure of risk for the particular client device based on the anomaly data and the shared data.

12. The storage medium of claim 11, wherein the instructions further cause the hardware processor to:
associate the anomaly data with a non-identifying characteristic of the particular client device;
generate, using the non-identifying characteristic, redacted anomaly data that includes a subset of the anomaly data received for the particular client device; and
provide the redacted anomaly data to one of the at least one computing devices that manage anomalies for a separate set of client devices.

13. The storage medium of claim 12, wherein the instructions further cause the hardware processor to:
determine, based on one of the non-identifying characteristic or the anomaly data, that a subset of the at least one computing devices is permitted to receive the redacted anomaly data, and wherein
the redacted anomaly data is only provided to computing devices in the subset.

14. The storage medium of claim 11, wherein:
the shared data relevant to the received anomaly data includes a risk indicator that corresponds to at least one of the anomalous network behavior data, ii) anomalous host event data, or iii) anomalous process activity data.

15. The storage medium of claim 11, wherein the instructions further cause the hardware processor to:
associate the anomaly data with a non-identifying characteristic of the particular client device, and
wherein the measure of risk is further based on other anomaly data associated with the non-identifying characteristic.
